(19) United States
(12) Patent Application Publication
(10) Pub. No.: US 2008/0238928 A1
(43) Pub. Date: Oct. 2, 2008

(54) FRAME BUFFER COMPRESSION FOR DESKTOP COMPOSITION

(76) Inventors: BIMAL PODDAR, EL DORADO HILLS, CA (US); TODD M. WITTER, ORANGEVALE, CA (US)

Correspondence Address: KACVINSKY LLC;C/O INTELLEVATE, P.O. BOX 52050, MINNEAPOLIS, MN, 55402, US

(21) Appl. No.: 11/693,889

(22) Filed: Mar. 30, 2007

(51) Int. Cl. G06T 9/00

(52) U.S. Cl. 345/555

(57) ABSTRACT

An apparatus may include two or more frame buffers, a control module, a management module, and a display engine. The two or more frame buffers may each store frame data arranged in a plurality of lines. The control module may designate one of the frame buffers for output. This designation may change for each frame output to a display device. The management module identifies the lines associated with the designated frame buffer as either valid or invalid. More particularly, the management module identifies a line as invalid when the line has changed in at least one of the two or more buffers since the designated buffer's previous designation for output. The display engine fetches, from the designated buffer, any lines identified as invalid. These fetched lines may be sent to the display device for output. Additionally, the fetched lines may be compressed and stored by the display engine.

### BACKGROUND

For graphics/multimedia applications, video data from a video source may be captured by a graphics chipset and displayed for viewing purposes. Within the graphics subsystem, video data (e.g., desktop image) may be stored or created in a frame buffer, and the memory for the frame buffer may be scanned out to a physical display. Some graphics chipsets support a memory bandwidth reduction technology known as frame buffer compression (FBC) such that, during the scan out operations, a display engine in the graphics hardware also compresses the frame buffer using Run Length Encoding (RLE) or other compression techniques. If the display surface has not changed during the scan out, then on the next scan out, the display engine can display the image using the compressed image instead of the full frame buffer. Using the compressed image reduces the amount of memory fetches and improves battery life.

In order for FBC to always display the correct image, the graphics chipset also may support detection of dirty lines. Namely, if some part of the frame buffer is updated by the operating system (OS) or by an application, certain rows of the frame buffer are invalidated. During the next scan out of the frame buffer, the display engine tries to fetch the frame buffer from the compressed buffer. If a row of the frame buffer is invalidated, however, the display engine fetches that line from the uncompressed buffer and tries to compress that line during the scan out.

This method of invalidating small regions of the frame buffer works well for an OS that employs and makes updates to a single frame buffer. However, this scheme breaks down for an OS (e.g., Microsoft's Windows Vista) in which the frame buffer is double buffered and generated by desktop composition where all the underlying content is composited together in a back buffer. Once the back buffer is generated, the OS issues a flip request for the driver/hardware to switch from the currently displayed front buffer to the back buffer. Since the flip request switches the displayed buffer completely, the traditional implementation of the FBC algorithm invalidates all the frame buffer lines.

### BRIEF DESCRIPTION OF THE DRAWINGS

FIG. 1 illustrates an apparatus embodiment.

FIG. 2 illustrates a logic flow.

FIG. 3 is a diagram illustrating operations over a sequence of frames.

FIG. 4 is a diagram illustrating the designation of dirty lines over a sequence of frames.

FIG. 5 illustrates a logic flow.

### DETAILED DESCRIPTION

Various embodiments may be generally directed to techniques involving the output of frames to a display device. For instance, in embodiments, an apparatus may include two or more frame buffers, a control module, a management module, and a display engine.

Each of the two or more frame buffers may store frame data arranged in a plurality of lines that each include multiple pixels. The control module may designate one of the frame buffers for output. This designation may change for each frame output to a display device. The management module identifies the lines associated with the designated frame buffer as either valid or invalid. More particularly, the management module identifies a line as invalid when the line has changed in at least one of the two or more buffers since the designated buffer's previous designation for output.

The display engine fetches, from the designated buffer, any lines identified as invalid. These fetched lines may be sent to the display device for output. Additionally, the fetched lines may be compressed and stored by the display engine. Further features and advantages will become apparent from the following description, claims, and accompanying drawings.

As described herein, embodiments may advantageously provide for reduced memory fetches. This, in turn, may lead to decreased latencies and lower power consumption.

Embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

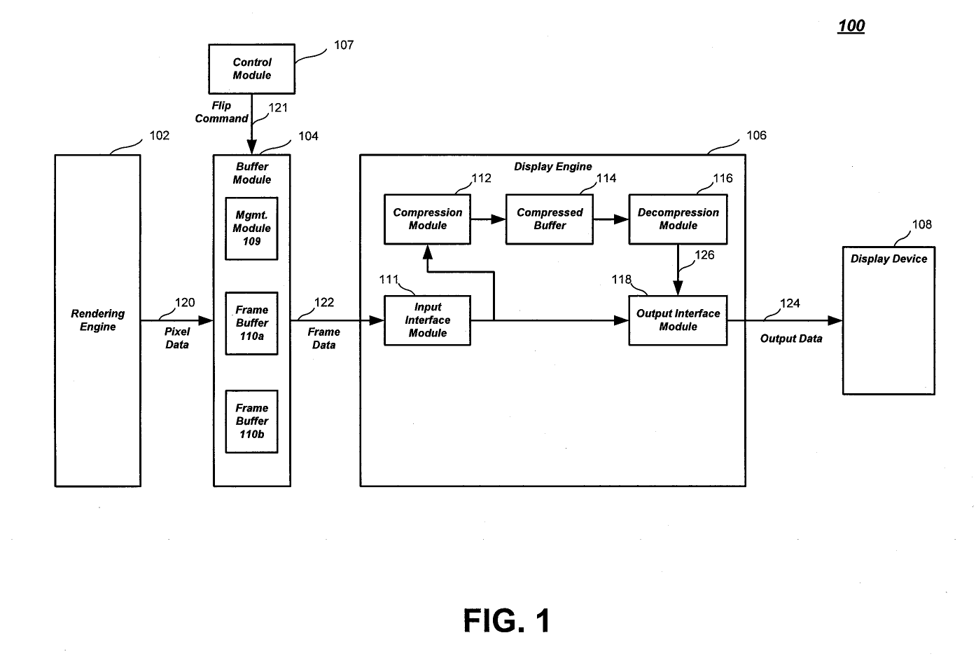

FIG. 1 illustrates one embodiment of an apparatus that may transfer signals across an interconnection medium. In particular, FIG. 1A shows an apparatus 100 comprising various elements. The embodiments, however, are not limited to these depicted elements. As shown in FIG. 1, apparatus 100 may include a rendering engine 102, a buffer module 104, a display engine 106, a control module 107, and a display device 108. These elements may be implemented in hardware, software, firmware, or any combination thereof.

Display device 108 may provide visual output to a user. This visual output may be in the form of sequentially occurring frames, each having multiple pixels. These frames may provide, for example, video, desktop images for graphical user interfaces and/or user applications. However, the embodiments are not limited to the presentation of such images.

Accordingly, display device 108 may be implemented with various technologies. For instance, display device 108 may be a liquid crystal display (LCD), a plasma display, or a cathode ray tube (CRT) display. However, other types of technologies and devices may be employed.

The pixels for each frame may originate from rendering engine 102. As shown in FIG. 1, rendering engine 102 generates pixel data 120. For example, rendering engine 102 may generate (or “draw”) pixel data 120 from models. These models may describe objects according to a graphics language or data format. However, the embodiments are not limited to this context. Pixel data 120 indicates the characteristics, such as color composition and intensity, for multiple pixels (e.g., pixels within a frame).

Multiple frame buffers may be used to store pixel data. For instance, FIG. 1 shows a buffer module 104 that has a first frame buffer 110a and a second frame buffer 110b. However, the embodiments are not limited to two frame buffers. For instance, embodiments may employ three or more frame buffers.

Each frame buffer 110 provides sufficient capacity to store an entire frame's worth of pixel data. Thus, together, frame buffers 110a and 110b may store pixel data for two consecutive frames. For instance, data for a sequence of frames may be alternatively stored in frame buffer 110a and frame buffer 110b. Considering a sequence of four consecutive frames, pixel data for the first frame may be stored in frame buffer 110a, pixel data for the second frame may be stored in frame buffer 110b, pixel data for the third frame may be stored in frame buffer 110a, and pixel data for the fourth frame may be stored in frame buffer 110b.

This alternate storage may be performed through a “flip” command 121. According to this command, one of frame buffers 110a and 110b (called the back buffer) is designated to receive pixel data 120 corresponding to a particular frame. In contrast, the other frame buffer (called the front buffer) is designated to output some or all of its content. This output is shown in FIG. 1 as frame data 122.

Once the back buffer has received its data, a further flip command 121 switches the front and back buffer designations. Thus, the previous front buffer may receive pixel data 120 for the subsequent frame and the previous back buffer may output some or all of its contents. Flip command 121 is issued for each successive frame. As a result, frame buffers 110a and 110b alternately store data for a sequence of frames.

Flip commands 121 are shown originating from control module 107. This aspect of control module may be included in various entities (such as operating system software, and so forth. However, the embodiments are not limited to this context.

Although FIG. 1 shows an implementation having two frame buffers, the embodiments are not so limited. For instance, implementations may include other quantities of frame buffers, where each frame buffer corresponds to a particular position or “time slot” within a repeating cycle in a sequence of frames. In such implementations, the frame buffer designated to output some or all of its contents may be referred to as the front buffer.

As described above, rendering engine 102 provides frame buffers 110 with pixel data 120 for a sequence of frames. This pixel data does not need to convey an entire pixel data set for each individual frame. For instance, pixel data 120 may be limited to providing buffers 110 with updates of frame portions that have changed. Various techniques may be employed to generate such updates. One such approach is referred to as the dirty rectangle technique.

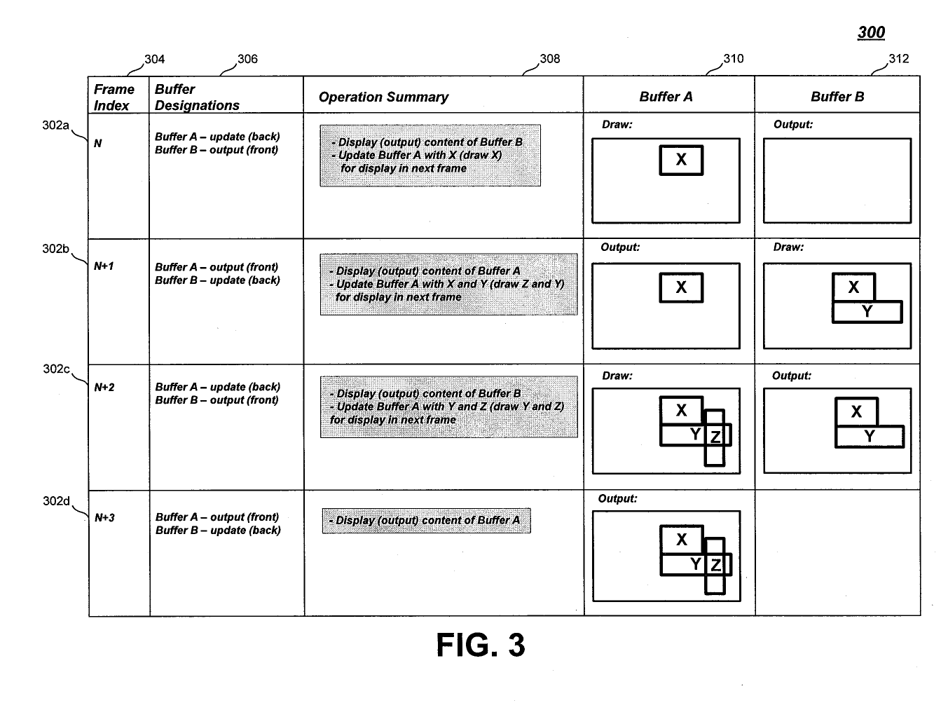

The dirty rectangle technique determines an area or rectangle of pixels that are affected by a change to an image (e.g., a change between two or more successive frames). Through this determination, pixel data 120 may include updated data for pixels within the dirty rectangle. Further details regarding the dirty rectangle approach are described below with reference to FIG. 3.

After pixel data for a frame has been stored in a frame buffer 110, the frame buffer's contents may be sent to display engine 106 as frame data 122. Upon receipt, display engine 106 may perform various operations on frame data 122. Such operations may include the compression and storage of frame data 122. Moreover, display engine 106 generates output data 124. This generation may involve various operations, such as the decompression of stored pixel data. Features of display engine 106 are described below in greater detail below.

As shown in FIG. 1, output data 124 is sent (or “scanned out”) to display device 108, which outputs (or displays) corresponding frames.

As described above, elements (such as frame buffers 110 and display engine 106) may both store frame data. These elements may arrange such stored data in the same manner. For instance, these elements may organize data for each frame into smaller portions. As an example, data for a particular frame may comprise multiple lines. Each of these lines includes data for multiple pixels. Such lines may correspond to visual portions within a frame image. Further, such lines may correspond to particular rows of pixels in a frame image. The embodiments, however, are not limited to this context.

Further, portions (e.g., lines) of stored frame data may be labeled as valid or invalid (also referred to as “clean” or “dirty”). Such labelings may be made by a management module 109. As shown in FIG. 1, management module 109 may be included in buffer module 104. The embodiments, however, are not limited to this context.

A valid or “clean” designation for a line stored within display engine 106 indicates that a corresponding line within the front frame buffer (e.g., either frame buffer 110a or 110b) contains the same pixel data. However, an invalid or “dirty” designation indicates that the corresponding line within the front frame buffer contains different pixel data.

As described above, display engine 106 receives frame data 122 and provides display device 108 with output data 124. FIG. 1 shows that display engine 106 may include an input interface module 111, a compression module 112, a compressed buffer 114, a decompression module 116, and an output interface module 118.

Input interface module 111 retrieves frame data 122 from buffer module 104. This may involve input interface module 111 fetching data from frame buffers 110 as individual portions (or lines) employed by frame buffers 110. For example, input interface module 111 may fetch particular frame buffer portions or lines that are designated as invalid or “dirty”.

Input interface module 111 forwards frame data 122 to compression module 112 and output interface module 118.

Compression module 112 compresses frame data 122. Such compression may be performed on a line-by-line (or portion-by-portion) basis. Once compressed, each line or portion is sent to compressed buffer 114.

This compression may be in accordance with various memory bandwidth reduction techniques. One such technique is called frame buffer compression (FBC). FBC involves the compression and storage of frame data. Run length encoding (RLE) techniques may be used to compress frames. However, other compression techniques may be employed. The compression of frames reduces the number of memory accesses. As a result, device power consumption may also be reduced. This may lead to increased operational times for battery powered devices.

Compressed buffer 114 receives compressed frame lines (or portions) from compression module 112 and stores them. As described above, these lines or portions are the same as employed by frame buffers 110. To provide such features, compressed buffer 114 may comprise a storage medium, such as memory.

Decompression module 116 may perform run length decoding on lines or portions of frames stored in compressed buffer 114. More particularly, such lines may be fetched for output to display device 108.

As described above, display engine 106 (e.g., input interface module 111) may individually fetch or retrieve certain lines or portions of frame data from display buffers 110. More particularly, display engine 106 may fetch (from such buffers) individual lines that are designated as invalid or “dirty”. A line is typically designated as dirty because the line stored by rendering engine 106 (e.g., in compressed buffer 114) differs from the corresponding frame buffer line data.

FIG. 1 shows that output interface module 118 provides display device 108 with output data 124. Output data 124 includes an entire frame's worth of data. In other words, output data 124 conveys data for every pixel (and thus every line) in frames to be displayed by display device 108.

Output interface module 118 produces output data 124 from frame data 122 and decompressed data 126. As described above, frame data 122 includes a frame's dirty lines retrieved from a particular buffer 110. Thus, decompressed data 126 includes the frame's remaining (if any) lines that are stored by compressed buffer 114 in compressed form.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

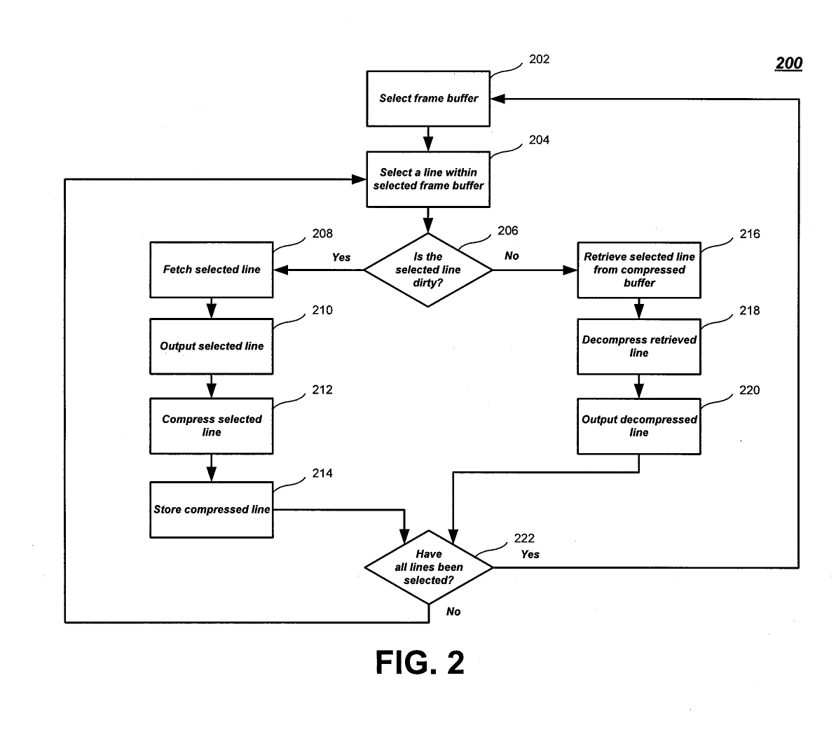

FIG. 2 illustrates one embodiment of a logic flow. In particular, FIG. 2 illustrates a logic flow 200, which may be representative of the operations executed by one or more embodiments described herein. For example, logic flow 200 may be employed by apparatus 100 in the displaying of frames.

As shown in FIG. 2, a block 202 selects a frame buffer. In the context of FIG. 1, block 202 selects one of frame buffers 110. For instance, block 202 may select a particular frame buffer 110 containing the current frame data for output by a display device 108. The frame buffer selected by block 202 may be referred to as the “front buffer”. The selection of a front buffer may on a periodic basis in accordance with a frame supported by a display device (e.g., display device 108).

A block 204 selects a line within the selected frame buffer. This selection may be performed according to a predetermined selection order.

A block 206 indicates whether the selected line is dirty. If so, then operation proceeds to a block 208. Otherwise, operation proceeds to a block 216.

As shown in FIG. 2, block 208 fetches the dirty line from the frame buffer. The fetched line is output to a display device (e.g., display device 108) by a block 210.

Also, a block 212 compresses the fetched line. The compressed line is stored (e.g., in compressed buffer 114) by a block 214.

FIG. 2 shows that block 216 is invoked when the selected line is not dirty. Block 216 retrieves the corresponding compressed line from the compressed buffer. Also, a block 218 decompresses this line. With reference to FIG. 1, such decompression may be performed by decompression module 116. This line is output to the display device by a block 220.

A block 222 determines whether all lines in the frame buffer have been selected. If not, then operation returns to block 202.

The logic flow of FIG. 2 shows that if a display surface has not changed between two successive frames, the second frame can be output (scanned out to the display) from the compressed buffer.

As described above, rendering engine 102 may generate pixel data updates for portions of frames that have changed. A dirty rectangle technique may be employed to generate such updates. FIG. 3 provides an example of this technique. In particular, FIG. 3 includes a table 300 illustrating operations over a sequence of four consecutive frames.

For instance, table 300 includes multiple rows 302. More particularly, FIG. 3 shows a row 302a that corresponds to a frame N, a row 302b that corresponds to a frame N+1, a row 302c that corresponds to a frame N+2, and a row 302d that corresponds to a frame N+3.

Each of these rows includes multiple columns. These columns include a frame index column 304, a frame buffer designations column 306, an operation summary column 308, a “Buffer A” column 310, and a “Buffer B” column 312.

The example of FIG. 3 may be employed in the context of FIG. 1. For instance, Buffer A may be implemented by frame buffer 110a and Buffer B may implemented by frame buffer 110b.

Row 302a corresponds to a frame N. In this frame, Buffer A is designated for updating and Buffer B is designated for output. Accordingly, Buffer A may be referred to as the “back buffer” and Buffer B the “front buffer”.

Thus, during frame N, the contents of Buffer B are output (displayed). In the context of FIG. 1, this may involve display engine 106 fetching from frame buffer 110b (as frame data 122) portions or lines that are designated as dirty. These fetched lines, along with any remaining decompressed portions from compressed buffer 114, may be sent to display device 108 as output data 124. FIG. 3 (at column 312 of row 302a) shows Buffer B being empty (i.e., as an empty box). However, in frame N, Buffer B may include content, as well as dirty portions.

Also, during frame N, the contents of Buffer A are updated to contain data (pixel data) for the next frame (frame N+1). With reference to FIG. 1, this may involve rendering engine 102 providing frame buffer 110a with pixel data 120.

As described above, dirty rectangle techniques may be employed in updating the contents of frame buffers. For instance, FIG. 3 (at column 310 of row 302a) shows Buffer A being updated with a dirty rectangle X. Dirty rectangle X encompasses changes that have occurred to a display area, such as a computer's desktop image, since the previous frame (frame N−1). Thus, in the context of FIG. 1, pixel data 120 does not necessarily contain data for every pixel in a particular frame.

In frame N+1, a “flip command” causes buffer designations to change. Accordingly, the second column of row 302b indicates that Buffer B is the back buffer and Buffer A is the front buffer. As a result of this, the lines of Buffer A that are designated as dirty are fetched. This dirty designation may be based on dirty rectangle X, as well as dirty lines identified in the previous frame's front buffer (i.e., Buffer A). Further details regarding the labeling of lines as dirty are provided below.

Once fetched, these dirty lines, along with any remaining decompressed portions from compressed buffer 114, may be sent to display device 108 as output data 124.

Conversely, Buffer B is updated in frame N+1. However, unlike the updating of Buffer A during frame N, the updating of Buffer B in frame N+1 involves two particular updates. The first update corresponds to changes to the display area since the previous frame (i.e., frame N). Such an update is shown in FIG. 3 (at column 310 of row 302b) as a dirty rectangle Y. Dirty rectangle Y encompasses display area changes since frame N.

The second update to Buffer B corresponds to changes in the display area since the last time Buffer B was updated. For instance, FIG. 3 (at column 310 of row 302b) shows Buffer B being further updated in frame N+1 with dirty rectangle X. As described above, dirty rectangle X represents a change to the display area from two frames ago. More particularly, dirty rectangle X encompasses a change between frame N−1 and frame N.

As shown in FIG. 3, another “flip” occurs in frame N+2. Thus, column 306 of row 302c shows that Buffer A is designated the back buffer and Buffer B is designated the front buffer.

Accordingly, with reference to FIG. 1, contents of Buffer B that are labeled dirty are fetched. These fetched portions, along with any remaining decompressed portions from compressed buffer 114, may be sent to display device 108 as output data 124.

Column 310 of row 302c shows that Buffer A is updated with a dirty rectangle Y and a dirty rectangle Z. Dirty rectangle Z encompasses changes to the display area since the previous frame (i.e., frame N+1). In contrast, dirty rectangle Y encompasses changes to the display area since the last time Buffer A was updated (i.e., in frame N).

In frame N+3, a further “flip” occurs. Accordingly, column 306 of row 302d indicates that Buffer B is the back buffer and Buffer A is the front buffer. Thus, with reference to FIG. 1, contents of Buffer B that are labeled as dirty are fetched for output to display device 108.

In this example, Buffer B is shown as having no updates in frame N+3. However, further examples may include such updates. Moreover, further examples may include subsequent frames.

As described above, lines may be invalidated (labeled dirty) based on changes. For instance, in single buffer implementations, frame buffer lines are invalidated when they contain changes from the previously displayed frame. Such frame buffer lines may be the lines that contain a dirty rectangle.

However, in implementations having multiple (e.g., two) frame buffers, invalidations may be based on other events. For instance, in previous approaches, a flip command triggers a complete invalidation in which all buffer lines are labeled dirty.

When such a complete invalidation occurs, no lines from a compressed frame buffer (such as compressed buffer 114) may be scanned out to a display. Instead, every line from the front frame buffer must be fetched and scanned out. For example, with reference to FIG. 1, a total invalidation would prompt display engine 106 to fetch every line (i.e., an entire frame's worth of data) from the front frame buffer (either buffer 110a or buffer 110b).

Thus, multiple buffer implementations employing such complete invalidation approaches may perform a relatively large number of fetch operations. As described above, this can lead to increased power consumption.

In contrast with prior approaches, embodiments may invalidate frame buffer lines in a more selective manner. For example, in a two frame buffer implementation, invalidation may be based on both the currently displayed frame and on the previously displayed frame.

More particularly, implementations having two frame buffers (such as the implementation of FIG. 1), may invalidate lines that contain both the current frame's dirty rectangle and the previous frame's dirty rectangle.

In implementations having more than two frame buffers, lines may be based on the current frame's dirty rectangle and the dirty rectangles of previous frames since the last time the current front buffer was the front buffer.

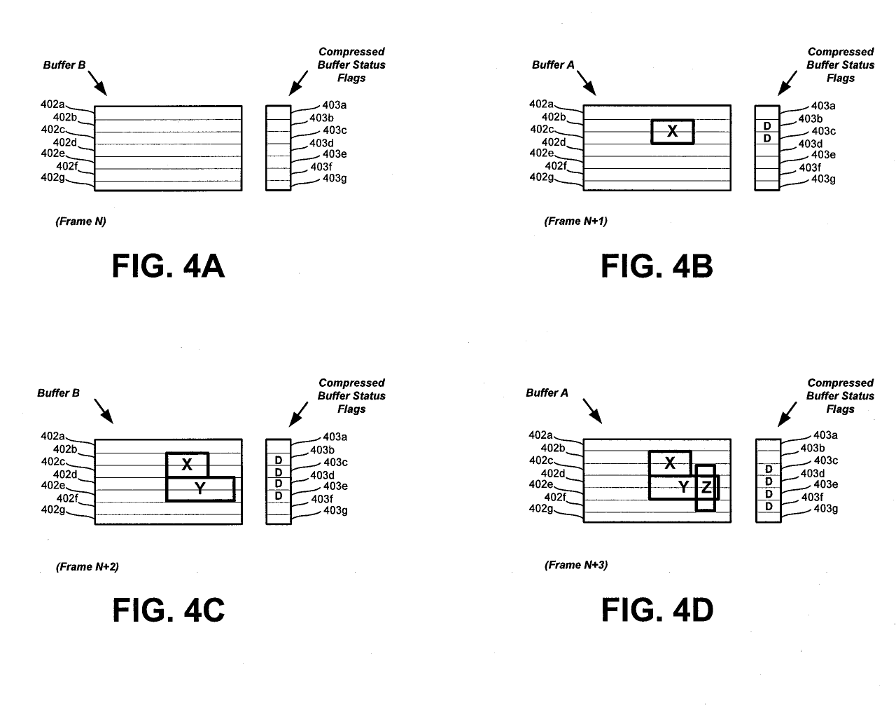

FIGS. 4A-4D provide examples of such line invalidation techniques. These drawings show the frame buffers of FIG. 3 (i.e., Buffers A and B) that were designated for output in frames N through N+3. More particularly, FIG. 4A shows Buffer B at frame N, FIG. 4B shows Buffer A at frame N+1, FIG. 4C shows Buffer B at frame N+2, and FIG. 4D shows Buffer A at frame N+3.

Moreover, FIGS. 4A-4D show that Buffers A and B each comprise multiple lines. For instance, these buffers are arranged into lines 402a-402g. Additionally, status flags are associated with these lines. For instance, FIGS. 4A-4D show status flags 403a-403g, which correspond to lines 402a-402g, respectively. Each of these flags, which corresponds to a compressed buffer (e.g., compressed buffer 114) indicates whether a corresponding buffer line is clean or dirty. For instance, flag 403a indicates whether line 402a is dirty, flag 403b indicates whether line 402b is dirty, and so forth. With reference to FIG. 1, flags 403 may be assigned and stored by management module 109.

FIG. 4A illustrates Buffer B at frame N. For this frame, status flags 403a-403g indicate no lines being dirty at this point. However, for frame N+1, FIG. 4B shows status flags 403b and 403c indicating (with a “D”) that lines 402b and 402c are dirty. Accordingly, these lines may be fetched from Buffer A for output to a display device. As shown in FIG. 4B, dirty lines 402b and 402c contain dirty rectangle X, which was provided to Buffer B for output in frame N+1.

FIG. 4C, which corresponds to frame N+2, shows status flags 403b-e indicating that lines 402b-e are dirty. Accordingly, lines 402b-402e of Buffer B may be fetched for output. These dirty lines include a first group corresponding to frame N+2 and a second group corresponding to frame N+1. The first group includes lines 402d and 402e, which contain dirty rectangle Y (provided to Buffer B for output in frame N+2). The second group includes lines 402b and 402c, which contain dirty rectangle X (first provided to Buffer A for output in frame N+1).

FIG. 4D corresponds to frame N+3. For this frame, status flags 403c-f indicate that lines 402c-f are dirty. As shown in FIG. 4D, these lines contain dirty rectangle Z (provided to Buffer B for output in frame N+3) and dirty rectangle Y (first provided to Buffer A for output in frame N+2). Thus, these lines constitute the union of two groups. The first group includes lines 402c-f, which contain dirty rectangle Z and correspond to frame N+3. The second group includes lines 402d-e, which contain dirty rectangle Y and correspond to frame N+2.

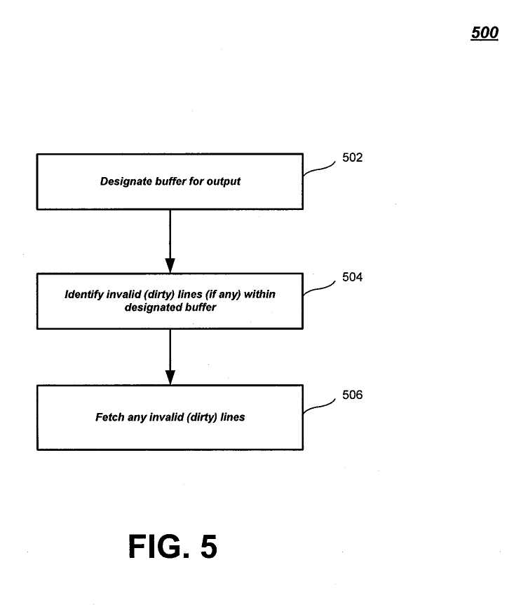

FIG. 5 is a flow diagram illustrating a logic flow 500, which may be representative of the operations executed by one or more embodiments described herein. For example, logic flow 500 may be employed by apparatus 100 in labeling of invalid or dirty lines.

As shown in FIG. 5, a block 502 designates a first of two or more frame buffers for output. For instance, with reference to FIG. 1, this designation may involve designating frame buffer 110a as the front buffer. In the context of FIG. 1, block 502 may be implemented with control module 107. The embodiments, however, are not limited to this example.

A block 504 then labels the lines associated with the designated frame buffer as either valid or invalid. This identification involves labeling a line as invalid when the line has changed in at least one of the two or more buffers (e.g., buffers 110a and 110b) since the designated buffer's previous designation for output.

Alternatively, this identification of block 504 may involve labeling a line as invalid when the line has contained at least a portion of a dirty rectangle in at least one of the two or more frame buffers since the designated frame buffer's previous designation for output.

With reference to FIG. 1, block 504 may be implemented with management module 109. However, other implementations may be employed.

Upon this identification, the dirty lines may be fetched from the designated buffer by a block 506. For instance, these lines (if any) may be fetched for output, compression, and storage. These operations may be performed as described above (e.g., with reference to FIGS. 1 and 2). However, the embodiments are not limited to these examples.

The features described above are provided as examples, and not as limitations. For instance, instead of employing a single compressed buffer (e.g., compressed buffer 114) and a single set of flags (e.g., flags 403) for multiple buffers, embodiments may handle multiple buffers with multiple compressed buffers—each with their own status flags.

Moreover, numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
two or more frame buffers, each frame buffer to store frame data arranged in a plurality of lines, the plurality of lines each comprising multiple pixels;
a control module to designate a first of the frame buffers for output;
a management module to identify the lines associated with the designated frame buffer as either valid or invalid;
a display engine to fetch, from the designated buffer, any lines identified as invalid;
wherein the management module is to identify a line as invalid when the line has changed in at least one of the two or more frame buffers since the designated frame buffer's previous designation for output.

2. The apparatus of claim 1, wherein the display engine is to compress and store each fetched invalid line in a compressed buffer.

3. The apparatus of claim 2, wherein the display engine is to compress each fetched invalid line according to a run length encoding (RLE) technique.

4. The apparatus of claim 1, wherein the display engine is to output any fetched invalid lines to a display device.

5. The apparatus of claim 4, further comprising the display device.

6. The apparatus of claim 1, wherein the display engine comprises a compressed buffer; and
wherein the display engine is to output any fetched invalid lines to a display device, and to fetch any remaining lines from the compressed buffer for decompression and output to the display device.

7. The apparatus of claim 1, further comprising a rendering engine;
wherein the control module is to designate a second of the two or more frame buffers for updating; and
wherein the rendering engine is to provide one or more updates to the second frame buffer.

8. The apparatus of claim 1, wherein the one or more updates includes a dirty rectangle.

9. The apparatus of claim 1, wherein the control module is to designate each of the two or more frame buffers for output according to a predetermined repeating pattern

10. The apparatus of claim 1, wherein each of the two or more frame buffers is designated for output during one or more particular frames in a sequence of frames.

11. The apparatus of claim 1, wherein the management module is to identify a line as invalid when the line has contained at least a portion of a dirty rectangle in at least one of the two or more frame buffers since the designated frame buffer's previous designation for output.

12. A method, comprising:
designating a first of two or more frame buffers for output;
identifying the lines associated with the designated frame buffer as either valid or invalid, said identifying comprising identifying a line of the designated frame buffer as invalid when the line has changed in at least one of the two or more buffers since the designated buffer's previous designation for output; and
fetching, from the designated buffer, any lines identified as invalid.

13. The method of claim 12, further comprising outputting any fetched invalid lines to a display device.

14. The method of claim 12, further comprising compressing each fetched invalid line.

15. The method of claim 14, wherein said compressing comprises compressing in accordance with a run length encoding (RLE) technique.

16. The method of claim 12, further comprising:
designating a second of the two or more frame buffers for updating; and
providing one or more updates to the second frame buffer, the one or more updates including a dirty rectangle.

17. An article comprising a machine-readable storage medium containing instructions that if executed enable a system to:
designate a first of two or more frame buffers for output;
identify the lines of the designated frame buffer as either valid or invalid, said identifying comprising identifying a line of the designated frame buffer as invalid when the line has changed in at least one of the two or more buffers since the designated buffer's previous designation for output; and
fetch, from the designated buffer, any lines identified as invalid.
